(19) United States
(12) Patent Application Publication
(10) Pub. No.: US 2026/0350739 A1
(43) Pub. Date: Nov. 5, 2026

(54) METHODS AND SYSTEMS FOR PERFORMING ZOOM OPERATIONS ON COMPUTING DEVICE

(71) Applicant: QUALCOMM Incorporated, San Diego, CA (US)

(72) Inventors: Nan ZHANG, Beijing (CN); Zhiguo LI, Beijing (CN); Wenkai YAO, Beijing (CN)

(21) Appl. No.: 19/478,465

(22) PCT Filed: Jun. 1, 2023
(86) PCT No.: PCT/CN2023/097687

§ 371 Date: Oct. 24, 2025

(51) Int. Cl. G06T 3/40; G06N 3/0464; G06T 13/80; G06V 10/25

(52) U.S. Cl. CPC G06T 3/40; G06N 3/0464; G06T 13/80; G06V 10/25

(57) ABSTRACT

Systems and methods for performing a zoom operation on a display of a computing device, which include identifying a region of interest (ROI) of an image presented on the display based on a zoom user input, determining a scaling factor for a final zoomed presentation of the ROI based on an image rendering requirement and/or an inference speed of a frame generation convolutional neural network (CNN), using the CNN to generate the final zoomed presentation of the ROI to the determined scaling factor, down-scaling the final zoomed presentation to generate a sequence of intermediate size image frames each having dimensions smaller than dimensions of the final zoomed presentation of the ROI and greater than dimensions of the ROI, and rendering an animation of changes in a displayed size of the ROI using the sequence of intermediate image frames of the ROI.

### BACKGROUND

Computing devices, such as smartphones, can utilize Artificial Intelligence (AI) for image processing using a dedicated AI processor or AI accelerator that is designed to run machine learning algorithms efficiently. The AI processor/accelerator also may execute convolutional neural networks (CNNs) as part of a CNN-based AI image processing system. CNNs are well suited for various image processing tasks such as image recognition, object detection, and image segmentation. However, such CNNs perform zoom operations on displayed images poorly, providing zoom animations that are perceivably not smooth. Such CNNs are also power hungry, consuming an inordinate amount of battery power. Consequently, in many computing devices, a run-time zoom or run-time magnify operation is only available within certain applications executing on the computing device.

### SUMMARY

Various aspects include methods of performing a zoom operation on a computing device. Some may aspects include identifying a region of interest (ROI) of an image presented on a display of the computing device based on a zoom user input received by the computing device, determining a scaling factor for a final zoomed presentation of the ROI based on one or both of an image rendering requirement or an inference speed of a frame generation convolutional neural network (CNN), using the CNN to generate the final zoomed presentation of the ROI to the determined scaling factor, down-scaling the final zoomed presentation to generate a sequence of intermediate size image frames each having dimensions smaller than dimensions of the final zoomed presentation of the ROI and greater than dimensions of the ROI, and rendering an animation of changes in a displayed size of the ROI using the sequence of intermediate image frames of the ROI.

In some aspects, the image rendering requirement may include a quantity of frames per second (FPS) generated by down-scaling the final zoomed presentation to the generated sequence of intermediate size image frames. In some aspects, down-scaling the final zoomed presentation to generate the sequence of intermediate size image frames may be performed using a linear scaling technique. In some aspects, determining the scaling factor for the final zoomed presentation and using the CNN to generate the final zoomed presentation may be performed in response to detecting an initiation of the user zoom input, and rendering the animation of changes in the displayed size of the ROI using the sequence of intermediate image frames may be performed responsive to the user zoom input.

In some aspects, determining the scaling factor for the final zoomed presentation of the ROI may be further based on dimensions of the ROI and dimensions of the display of the computing device. In some aspects, determining the scaling factor for the final zoomed presentation of the ROI may be further based on dimensions of an image element within the ROI and dimensions of the display of the computing device. In some aspects, generating a sequence of upscaled image frames of elements of the display outside of the ROI using an interpolation scaling technique. In such aspects, rendering the animation of changes in the displayed size of the ROI using the sequence of intermediate image frames of the ROI may include rendering an animation on the display that combines the sequence of intermediate image frames of the ROI and the sequence of upscaled image frames of elements of the image outside of the ROI.

Further aspects may include a computing device having a processor configured with processor-executable instructions to perform various operations corresponding to the methods discussed above. Further aspects may include a non-transitory processor-readable storage medium having stored thereon processor-executable instructions configured to cause a processor to perform various operations corresponding to the method operations discussed above. Further aspects may include a computing device having various means for performing functions corresponding to the method operations discussed above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a conceptual diagram illustrating aspects of a method for performing a zoom operation on a computing device in accordance with various embodiments.

FIGS. 2A and 2B illustrate an example neural network 200 suitable for implementation in a computing device in accordance with various embodiments.

FIGS. 3A and 3B illustrate example functionality components that may be included in a convolutional neural network, which may be implemented in a computing device that is configured to implement a generalized framework for continual learning in accordance with various embodiments.

FIG. 4 is a component block diagram illustrating an example computing system implemented as a system in a package (SIP) suitable for implementing various embodiments.

FIG. 5A illustrates a method of performing a zoom operation on a computing device according to various embodiments.

FIG. 5B illustrates operations that may be performed as part of the method of performing a zoom operation on a computing device according to various embodiments.

FIG. 6 is a component block diagram illustrating an example computing device suitable for use with various embodiments.

FIG. 7 is a component block diagram illustrating an example wireless communication device suitable for use with various embodiments.

FIG. 8 illustrates an example wearable computing device in the form of a smart watch suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In overview, various embodiments include methods, and computing devices configured to implement the methods, for performing a zoom operation on an image or text on a display of a computing device in response to a user input for zooming the image or text. Various embodiments may include responding to a user input for a zoom operation (a “zoom user input”) by identifying a region of interest (ROI) within the image rendered on a display of the computing device, and determining a final size or zooming factor for the identified ROI. The zoom operation may include using CNN image processing to generate an enlarged image of the ROI at the final size or zooming factor, generating a sequence of down-scaled images that are smaller versions of the enlarged image of the ROI using linear downscaling operations, and then produce a zoom animation by sequentially rendering the down-scaled images beginning with the original ROI, continuing with increasingly larger images and ending with the enlarged image of the ROI at the final size or zooming factor. In this manner, the enlarged image of the ROI at the final size or zooming factor may exhibit the fine resolution enabled through the use of CNN image processing while providing a smooth animation without the power consumption that would be required to generate all images in the animation using CNN processing.

The term “computing device” may be used herein to refer to any one or all of quantum computing devices, Edge computing devices, Internet access gateways, modems, routers, network switches, residential gateways, access points, integrated access devices (IAD), mobile convergence products, networking adapters, multiplexers, personal computers, laptop computers, tablet computers, user equipment (UE), smartphones, personal or mobile multi-media players, personal data assistants (PDAs), palm-top computers, wireless electronic mail receivers, multimedia Internet enabled cellular telephones, gaming systems (e.g., PlayStation™, Xbox™, Nintendo Switch™, etc.), wearable devices (e.g., smartwatch, head-mounted display, fitness tracker, etc.), media players (e.g., DVD players, ROKU™, AppleTV™, etc.), digital video recorders (DVRs), automotive displays, portable projectors, 3D holographic displays, and other similar devices that include a display and a programmable processor that can be configured to provide the functionality of various embodiments.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC also may include any number of general purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. SoCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard, in a single UE, or a single CPU device. The proximity of the SoCs facilitates high speed communications and the sharing of memory and resources.

The term “neural network” is used herein to refer to an interconnected group of processing nodes (e.g., neuron models, etc.) that collectively operate as a software application or process that controls a function of a computing device or generates a neural network inference. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and activation. The weight values may be determined during a training phase and iteratively updated as data flows through the neural network.

Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The final layer of nodes may be referred to as an output layer. The layers in-between the input and final layer may be referred to as intermediate layers, hidden layers, or black-box layers. Each layer in a neural network may have multiple inputs, and thus multiple previous or preceding layers. Said another way, multiple layers may feed into a single layer. For ease of reference, some of the embodiments are described with reference to a single input or single preceding layer. However, it should be understood that the operations disclosed and described in this application may be applied to each of multiple inputs to a layer as well as multiple preceding layers.

The term “convolutional neural network” (CNN) is used herein to refer to a deep neural network in which the computation in at least one layer is structured as a convolution. A convolutional neural network may also include multiple convolution-based layers, which allows the neural network to employ a very deep hierarchy of layers. In convolutional neural networks, the weighted sum for each output activation is computed based on a batch of inputs, and the same matrices of weights (called “filters”) are applied to every output. These networks may also implement a fixed feedforward structure in which all the processing nodes that make up a computational chain are used to process every task, regardless of the inputs. In such feed-forward neural networks, all of the computations are performed as a sequence of operations on the outputs of a previous layer. The final set of operations generate the overall inference result of the neural network, such as a probability that an image contains a specific object (e.g., a person, cat, watch, edge, etc.) or information indicating that a proposed action should be taken.

The term “inference” may be used herein to refer to a process that is performed at runtime or during execution of the software application program corresponding to the neural network. Inference may include traversing the processing nodes in the neural network along a forward path to produce one or more values as an overall activation or overall “inference result.”

A computing device may include a display and graphics hardware or subsystem that utilizes Artificial Intelligence (AI) to enhance the performance and capabilities of the display and graphics processing. In a computing device that utilizes AI for image processing, the hardware may include a dedicated AI processor or an AI accelerator that is designed to run machine learning algorithms more efficiently than the other processors. CNNs are one of the most commonly used AI methods for image processing.

In a computing device with a CNN-based AI image processing system, the CNNs may be run on the AI processor or accelerator to analyze and process images that are to be displayed on the computing device's screen. Using AI image processing systems may improve the performance and efficiency of the computing device's display and graphics. AI image processing systems may also enhance a user's experience by supporting features such as improved image quality, real-time image enhancement, and more realistic virtual reality and augmented reality experiences. For example, an AI image processing systems may be used to enhance the realism of virtual and augmented reality experiences by improving the 3D graphics rendering and object tracking.

Bilinear and bicubic scalars are interpolation scaling techniques that may be used to resize or scale images. For example, bilinear or bicubic scalars may be used to change the size of an image by either increasing or decreasing the number of pixels it contains. Bilinear scaling may include using linear interpolation to determine the value of new pixels based on the values of nearby pixels in the original image. Bilinear scaling is particularly useful when the original image is smooth and does not contain many fine details. Bilinear scaling may cause loss of detail and blurring when used to magnify images with high levels of detail or texture. Bicubic scaling is a more complex technique that uses cubic interpolation to determine the values of new pixels based on the values of nearby pixels in the original image. Bicubic scaling may produce better results than bilinear scaling, particularly when scaling up images, with a wide range of image types, including those with high levels of detail or texture. Bicubic scaling may be slower or more processor intensive than bilinear scaling. Both bilinear and bicubic scaling techniques may be used for image zooming, upscaling and downscaling.

AI super resolution is a technique that may be used to increase the resolution of an image or video. AI super resolution is commonly used in image and video processing tasks to improve the visual quality of the image or video. AI super resolution may be implemented by CNNs that take a low-resolution image as input and generate a high-resolution version of the image as output. AI super resolution may be used to enhance the visual quality of an image and/or video, and may be used for image zooming and upscaling. AI super resolution may be slower than bilinear and bicubic scaling, but generally produces a much higher image quality.

Some applications that execute on computing devices, and in particular on mobile computing devices (e.g., smart phones), such as map applications and some web browser applications, provide run time zoom or run time magnify functions for content generated by the application. For example, some map applications enable zooming in on map content within the map application. Such applications support the ability to zoom into content within the application in response to a user input to a touchscreen device or trackpad device (a “zoom user input”). For example, a zoom user input may include increasing a distance between two fingers in contact with a touchscreen (sometimes called a “reverse pinch” or “pinch out” gesture), a double-tap and drag gesture, or another suitable user input.

However, computing devices typically do not provide run time zoom functions generally outside of such applications, in part because neither bilinear/bicubic image scaling nor AI (CNN) based super resolution is well-suited to the task. Bilinear or bicubic image scaling typically does not provide sufficient content details, and AI (CNN) based super resolution does not provide smooth animations, and further consumes battery power at an undesired rate.

For example, a CNN model may execute or generate every frame (e.g., either in a graphics processing unit (GPU) or digital signal processor (DSP)) to provide CNN super resolution-based hybrid scaling/zooming animations. A typical hybrid CNN super resolution function causes significant power consumption and may struggle to provide smooth animations (e.g., without visible frame drops), particularly for advanced display screens that provide up to 120 Hz or 144 Hz display rates.

Various embodiments include methods and computing devices configured to perform the methods of performing a zoom operation on a computing device. In some embodiments, a processor of the computing device may identify a region of interest (ROI) of an image presented on a display of the computing device based on a zoom user input received by the computing device. In some embodiments, a processor of the computing device may use a regional histogram analysis and/or image segmenting to identify the ROI. For example, a thumbnail image presented on a solid or low texture background may be identified by the processor based on the pixel variability within the thumbnail image (as revealed in a histogram of the region) compared to the low variability of pixels within the background.

In some embodiments, a processor of the computing device may determine a scaling factor for a final zoomed presentation of the ROI based on information available to the processor. In some embodiments, the processor may determine the scaling factor based on how much the ROI can be enlarged and remain within the dimensions of the display or comply with another image rendering requirement. In some embodiments, the processor may determine the scaling factor based on how fast a final image can be generated using CNN processing methods and processors available on the computing device (referred to as an inference speed of a frame generation CNN). In some embodiments, the computing device processor may determine (compute, identify) dimensions of the ROI (such as a width and height), and dimensions of a display of the computing device (such as a width and height, a number of vertical pixels and horizontal pixels, or other suitable dimensions). In some embodiments, the computing device may determine a time and/or number of frames needed to expand the ROI to fill the available display dimensions, e.g., in one or more dimensions.

In some embodiments, the computing device may identify dimensions of an image element within the ROI. For example, the computing device may identify a face within a photograph, and may determine a time and/or number of frames needed to expand the face (the image element within the ROI) to fill the available display dimensions. In some embodiments, the image rendering requirement may include a quantity of frames per second (FPS) generated by down-scaling the final zoomed presentation to the generated sequence of intermediate size image frames. In some embodiments, determining the scaling factor for the final zoomed presentation of the ROI is further based on dimensions of the ROI and dimensions of the display of the computing device. In some embodiments, determining the scaling factor for the final zoomed presentation of the ROI may be further based on dimensions of an image element within the ROI and dimensions of the display of the computing device. In some embodiments, the computing device may determine the scaling factor for the final zoomed presentation in response to detecting initiation of a user zoom input (e.g., touches of two fingers on a touch-sensitive display).

In some embodiments, the computing device processor may use CNN processes to generate the final zoomed presentation of the ROI to the determined scaling factor. Then to generate a zoom animation from the original ROI to the final zoomed presentation of the ROI, the computing device processor may down-scale the final zoomed presentation to generate a sequence of intermediate size image frames each having dimensions smaller than dimensions of the final zoomed presentation of the ROI and greater than dimensions of the ROI. In some embodiments, down-scaling the final zoomed presentation to generate a sequence of intermediate size image frames may be performed using a linear scaling technique. In some embodiments, the computing device may render an animation of changes in a displayed size of the ROI using the sequence of intermediate image frames of the ROI beginning with the original ROI image and sequentially presenting ever increasing size intermediate image frames until the final zoomed presentation of the ROI is displayed. In some embodiments, the computing device may render the animation of changes in displayed sizes of the ROI using the sequence of intermediate image frames responsive to the user zoom input.

As a user may focus attention on the ROI during a zoom animation, in some embodiments, the computing device processor render the zoom animation of the ROI in greater resolution than a zoom animation of surrounding images (e.g., background pixels). For example, in some embodiments, the processor may generate a sequence of upscaled image frames of the display outside of the ROI using linear interpolation scaling techniques, while rendering the animation of the ROI zoom using the CNN upscaled image and down-scaled frames, presenting on the display a combination of the sequence of intermediate image frames of the ROI and the sequence of upscaled image frames of elements of the image outside of the ROI.

For example, the computing device processor may identify an ROI using regional histogram analysis an image segmenting. The computing device processor may determine a scaling factor for a final zoomed presentation of the ROI (or for an image element within the ROI) by determining dimensions of the ROI (or dimensions of the image element), dimensions of the display, and/or a time required by the CNN to generate a zoomed presentation of the ROI or image element. For example, the computing device processor may determine that generating a zoomed presentation of the ROI or image element using a 2× scaling factor may require 27 milliseconds, generating a zoomed presentation of the ROI or image element 3× scaling factor may require 35 milliseconds, and that generating a zoomed presentation of the ROI or image element 4× scaling factor may require 52 milliseconds. In some embodiments, the computing device processor may select a scaling factor based on one or more latency requirements, such as a frames-per-second threshold, a touch delay latency requirement, or another suitable latency requirement or threshold.

Continuing this example, the computing device processor may use the CNN to generate a final zoomed presentation of the ROI or image element using the determined scaling factor. For example, if the computing device processor selects a 2× scaling factor for an ROI having dimensions 540×320, the computing device processor may upscale or zoom the ROI or image element using the 2× scaling factor to generate the final zoomed presentation of the ROI upscaled to 1080×640. The computing device processor may downscale the final zoomed presentation of the ROI or image element to generate a sequence of intermediate size image frames. The intermediate size image frames may have dimensions that are greater than the dimensions of the ROI, and are less than the dimensions of the final zoomed presentation of the ROI. For example, the computing device processor may generate a first animation frame having dimensions 550×324, a second animation frame having dimensions 570×335, and so forth, up to a final intermediate frame N. In some embodiments, the processor may use a linear scaling technique to generate the sequence of intermediate size image frames. The computing device processor may then render an animation of changes in the displayed size of the ROI or image element using the sequence of intermediate image frames of the ROI. In some embodiments, the computing device processor may stop the zoom animation short of the final zoomed image. In various embodiments, if the displayed content or content geometry changes, the computing device processor may dynamically update the ROI and perform the various operations described above for the dynamically updated ROI.

In some embodiments, the computing device processor may use a combination of the CNN and an interpolation scaling technique generate a zoom animation for the ROI and a region outside of the ROI. For example, the computing device processor may generate a sequence of upscaled image frames of elements of the display outside of the ROI using an interpolation scaling technique. The computing device processor may then render an animation on the display that combines the sequence of intermediate image frames of the ROI and the sequence of upscaled image frames of elements of the image outside of the ROI.

Various embodiments improve the user experience of users performing a zoom operation on an image element on a computing device by enabling a computing device processor to provide a run-time zoom function for nearly any content presented by the computing device, and that is not limited to zoom operations performed within a specific application that is dependent on the design and functions of the specific application.

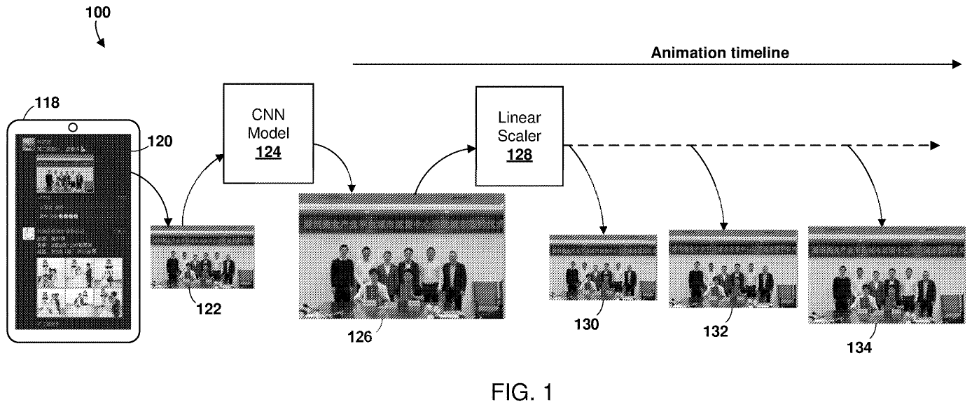

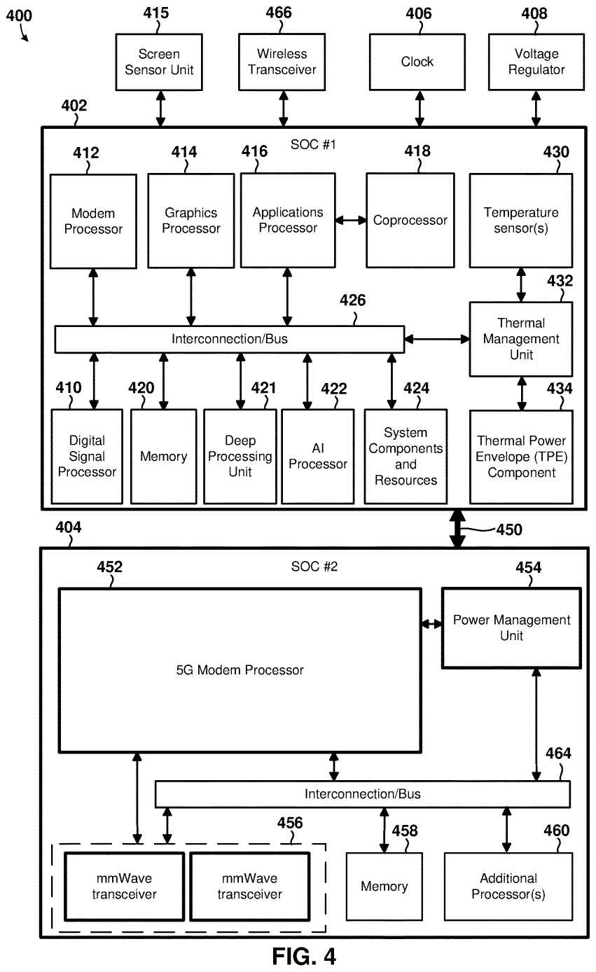

FIG. 1 is a conceptual diagram illustrating aspects of a method 100 for performing a zoom operation on a computing device in accordance with various embodiments. Means for performing operations of the method 100 may include one or more processors (e.g., processors 410, 412, 414, 416, 418, 421, 422, 452, 460 in FIG. 4) in a computing device (e.g., 118, 400).

The computing device 118 may identify a region of interest (ROI) 122 of an image 120 presented on a display of the computing device 118 based on a zoom user input received by the computing device 118 (e.g., received by a touchscreen input device of the computing device 118). In some embodiments, the computing device 118 may use a regional histogram analysis and/or image segmenting to identify the ROI 122.

The computing device 118 may determine a scaling factor for a final zoomed presentation of the ROI 126 based on one or both of an image rendering requirement or an inference speed of a frame generation convolutional neural network (CNN) (“CNN model”) 124. In some embodiments, the computing device 118 may determine (compute, identify) dimensions of the ROI 122 (such as a width and height). In some embodiments, the computing device may determine dimensions of a display of the computing device 118 (such as a width and height, a number of vertical pixels and horizontal pixels, or other suitable dimensions). In some embodiments, the computing device may determine a time and/or number of frames needed to expand the ROI 122 to fill the available display dimensions of the computing device 118.

In some embodiments, the computing device may identify dimensions of an image element within the ROI 122, such as a face, or any other suitable image element. For example, the computing device 118 may identify a face within the ROI 122, and may determine a time and/or number of frames needed to expand the face to fill display dimensions of the computing device 118.

In some embodiments, the image rendering requirement may include a quantity of frames per second (FPS) generated by down-scaling the final zoomed presentation to the generated sequence of intermediate size image frames. In some embodiments, determining the scaling factor for the final zoomed presentation of the ROI 122 may be further based on dimensions of the ROI 122 and dimensions of the display of the computing device 118. In some embodiments, determining the scaling factor for the final zoomed presentation of the ROI 122 may be further based on dimensions of an image element within the ROI 122 and dimensions of the display of the computing device 118. In some embodiments, the computing device 118 may determine the scaling factor for the final zoomed presentation in response to detecting and initiation of a user zoom input.

The computing device 118 may use the CNN 124 to generate the final zoomed presentation 126 of the ROI 122 to the determined scaling factor. The computing device 118 may use a linear scaler 128 to down-scale the final zoomed presentation 126 to generate a sequence of intermediate size image frames 130, 132, 134, each having dimensions smaller than dimensions of the final zoomed presentation 126 of the ROI 122 and greater than dimensions of the ROI 122. The computing device may render an animation in an animation timeline of changes in a displayed size of the ROI 122 using the sequence of intermediate image frames 130, 132, and 134. Based on aspects of the zoom user input, such as velocity of the input, distance of the input, or another magnitude, the animation may reach (ultimately display) the final zoomed presentation 126 of the ROI 122, or the animation may not reach the final zoomed presentation 126 of the ROI 122 an instead may reach (ultimately display) one of the intermediate image frames 130, 132, and 134.

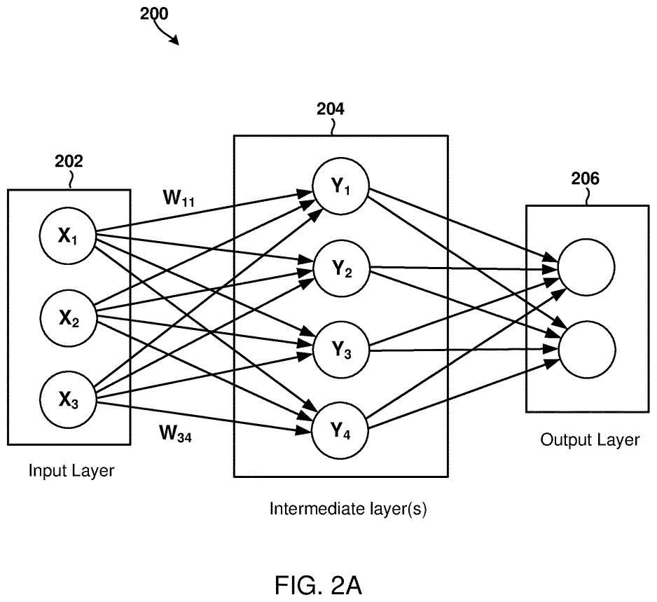

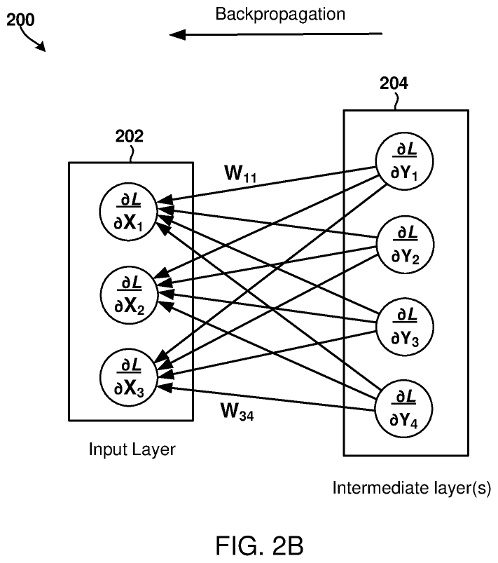

FIGS. 2A and 2B illustrate an example neural network 200 suitable for implementation in a computing device in accordance with various embodiments. With reference to FIGS. 1-2A, the neural network 200 may include an input layer 202, intermediate layer(s) 204, and an output layer 206. Each of the layers 202, 204, 206 may include one or more processing nodes that receive input values, perform computations based the input values, and propagate the result (activation) to the next layer.

In feed-forward neural networks, such as the neural network 200, all of the computations are performed as a sequence of operations on the outputs of a previous layer. The final set of operations generate the output of the neural network, such as a probability that an image contains a specific item (e.g., dog, cat, etc.) or information indicating that a proposed action should be taken. The final output of the neural network may correspond to a task that the neural network 200 may be performing, such as determining whether an image contains a specific item (e.g., dog, cat, etc.). Many neural networks 200 are stateless. The output for an input is always the same irrespective of the sequence of inputs previously processed by the neural network 200.

The neural network 200 may include fully-connected (FC) layers, which are also sometimes referred to as multi-layer perceptrons (MLPs). In a fully-connected layer, all outputs are connected to all inputs. Each processing node's activation is computed as a weighted sum of all the inputs received from the previous layer.

An example computation performed by the processing nodes and/or neural network 200 may be:

$${y}_{i} = f ( {\sum }_{i = 1}^{3} {W}_{ij} * {x}_{i} + b )$$

in which Wᵢⱼ are weights, xi is the input to the layer, yⱼ is the output activation of the layer, f(⋅) is a non-linear function, and b is bias, which may vary with each node (e.g., bⱼ). As another example, the neural network 200 may be configured to receive pixels of an image (i.e., input values) in the first layer, and generate outputs indicating the presence of different low-level features (e.g., lines, edges, etc.) in the image. At a subsequent layer, these features may be combined to indicate the likely presence of higher-level features. For example, in training of a neural network for image upscaling, the output layer may generate a probability value that various lines, edges, colors, etc. are present in an enlarged (i.e., upscaled) version of the input image. In this manner the neural network can use the information available in a low-resolution small image to predict elements of the image that should be added to fill in details between pixels as the image is enlarged.

The neural network 200 may be trained to upscale images using a database of images of different sizes and resolutions. In this training process a small image may be provided as the input and a larger, higher resolution image of the same subject matter may be provides as the expected/desired output. Learning is accomplished by comparing the output generated by the neural network 200 to the expected/desired output and adjusting weights. The difference between the expected/desired output and the output generated by the neural network 200 is referred to as loss (L). The weights and biases in the neural network are then adjusted to bring the output image closer to the provided expected output image, thereby reducing the loss. During training, the weights (wᵢⱼ) may be updated using a hill-climbing optimization process called “gradient descent.” This gradient indicates how the weights should change in order to reduce loss (L). A multiple of the gradient of the loss relative to each weight, which may be the partial derivative of the loss

$$( e . g , \frac{\partial L}{\partial X 1} , \frac{\partial L}{\partial X 2} , \frac{\partial L}{\partial X 3} )$$

with respect to the weight, could be used to update the weights and biases. This learning process may be repeated for a large database of images.

FIG. 2B illustrates a manner of computing partial derivatives of a gradient through a process called backpropagation. With reference to FIGS. 1-2B, backpropagation may operate by passing values backwards through the network to compute how the loss is affected by each weight. The backpropagation computations may be similar to the computations used when traversing the neural network 200 in the forward direction (i.e., during inference). To improve performance, the loss (L) from multiple sets of input data (“a batch”) may be collected and used in a single pass of updating the weights. Many passes may be required to train the neural network 200 with weights suitable for use during inference (e.g., at runtime or during execution of a software application program).

The overall structure of the neural network 200, and operations of the processing nodes, do not change as the neural network learns this task. After such training is completed, the neural network 200 may process any image for upscaling using the determined weights and bias.

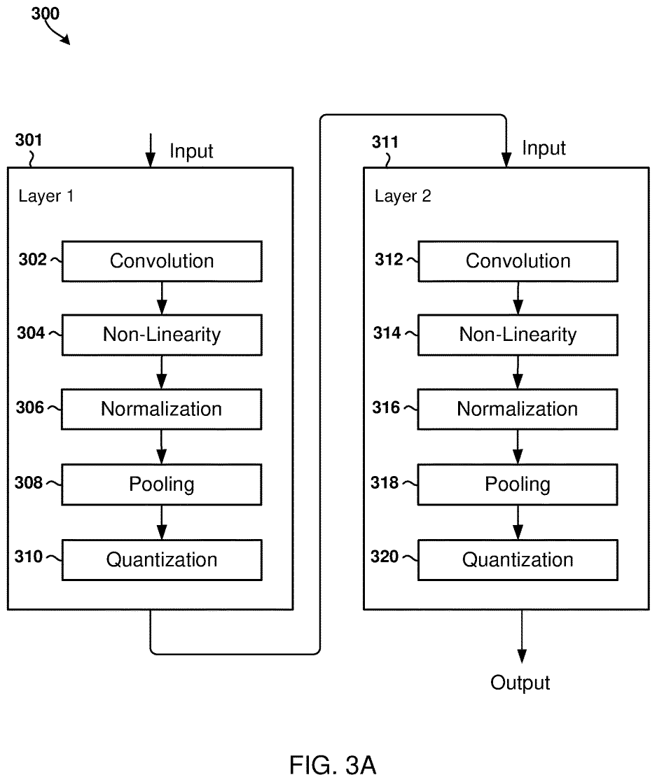

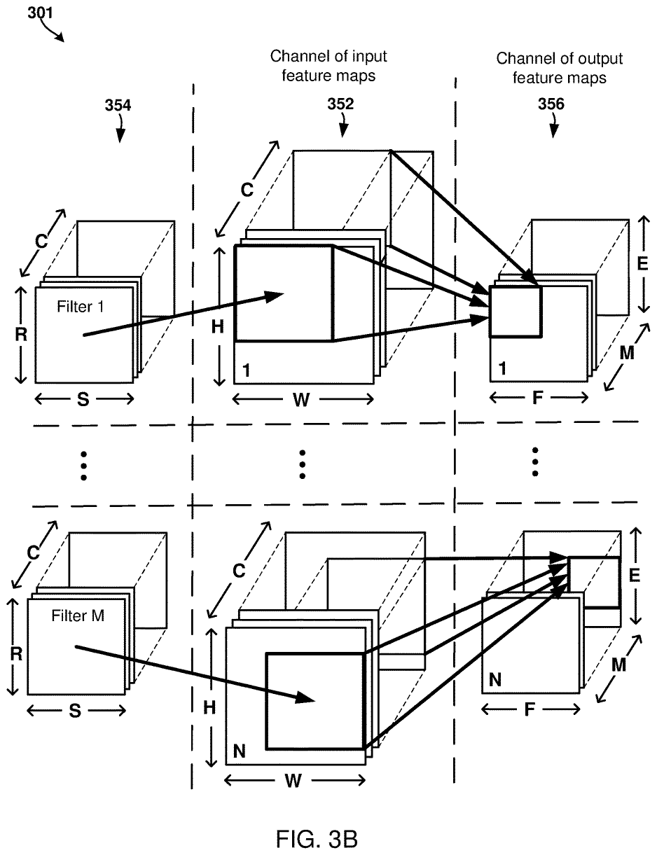

FIGS. 3A and 3B illustrate example functionality components that may be included in a convolutional neural network 300, which may be implemented in a computing device that is configured to implement a generalized framework for continual learning in accordance with various embodiments.

With reference to FIGS. 1-3B, the convolutional neural network 300 may include a first layer 301 and a second layer 311. Each layer 301, 311 may include one or more activation functions. In the example illustrated in FIG. 3A, each layer 301, 311 includes convolution functionality component 302, 312, a non-linearity functionality component 304, 314, a normalization functionality component 306, 316, a pooling functionality component 308, 318, and a quantization functionality component 310, 320. It should be understood that, in various embodiments, the functionality components 302-310 or 312-320 may be implemented as part of a neural network layer, or outside the neural network layer. It should also be understood that the illustrated order of operations in FIG. 3A is merely an example and not intended to limit various embodiments to any given operation order. In various embodiments, the order and/or inclusion of the operations of functionality components 302-310 or 312-320 may change in any given layer. For example, normalization operations by the normalization functionality component 306, 316 may come after convolution by the convolution functionality component 302, 312 and before non-linearity operations by the non-linearity functionality component 304, 314.

The convolution functionality component 302, 312 may be an activation function for its respective layer 301, 311. The convolution functionality component 302, 312 may be configured to generate a matrix of output activations called a feature map. The feature maps generated in each successive layer 301, 311 typically include values that represent successively higher-level abstractions of input data (e.g., line, shape, object, etc.).

The non-linearity functionality component 304, 314 may be configured to introduce nonlinearity into the output activation of its layer 301, 311. In various embodiments, this may be accomplished via a sigmoid function, a hyperbolic tangent function, a rectified linear unit (ReLU), a leaky ReLU, a parametric ReLU, an exponential LU function, a maxout function, swish, etc.

The normalization functionality component 306, 316 may be configured to control the input distribution across layers to speed up training and the improved accuracy of the outputs or activations. For example, the distribution of the inputs may be normalized to have a zero mean and a unit standard deviation. The normalization function may also use batch normalization (BN) techniques to further scale and shift the values for improved performance.

The pooling functionality components 308, 318 may be configured to reduce the dimensionality of a feature map generated by the convolution functionality component 302, 312 and/or otherwise allow the convolutional neural network 300 to resist small shifts and distortions in values.

In some embodiments, the inputs to the first layer 301 may be structured as a set of three-dimensional input feature maps 352 that form a channel of input feature maps. For example, the convolutional neural network 300 may include a batch size of N three-dimensional feature maps 352 with height H and width W each having C number of channels of input feature maps (illustrated as two-dimensional maps in C channels), and M three-dimensional filters 354 including C filters for each channel (also illustrated as two-dimensional filters for C channels). Applying the 1 to M filters 354 to the 1 to N three-dimensional feature maps 352 results in N output feature maps 356 that include M channels of width F and height E. As illustrated, each channel may be convolved with a three-dimensional filter 354. The results of these convolutions may be summed across all the channels to generate the output activations of the first layer 301 in the form of a channel of output feature maps 356. Additional three-dimensional filters may be applied to the input feature maps 352 to create additional output channels, and multiple input feature maps 352 may be processed together as a batch to improve the reuse of the filter weights. The results of the output channel (e.g., set of output feature maps 356) may be fed to the second layer 311 in the convolutional neural network 300 for further processing.

FIG. 4 is a component block diagram illustrating an example computing system implemented as a system in a package (SIP) 400 suitable for implementing various embodiments. With reference to FIGS. 1-4, various embodiments may be implemented in a variety of architectures that may be used in computing devices, including single processor, multiple processor, and multiprocessor computer systems, a system-on-chip (SOC), a SIP, and any combination thereof.

The SIP 400 may include a two SOCs 402, 404, a clock 406, and a voltage regulator 408. In some embodiments, the first SOC 402 may operate as central processing unit (CPU) of the computing device that carries out the instructions of software application programs by performing the arithmetic, logical, control and input/output (I/O) operations specified by the instructions. In some embodiments, the second SOC 404 may operate as a specialized processing unit. For example, the second SOC 404 may operate as a specialized 5G processing unit responsible for managing high volume, high speed (e.g., 5 Gbps, etc.), and/or very high frequency short wavelength (e.g., 28 GHz mmWave spectrum, etc.) communications.

The first SOC 402 may include a digital signal processor (DSP) 410, a modem processor 412, a graphics processor 414, an application processor 416, one or more coprocessors 418 (e.g., vector co-processor) connected to one or more of the processors, memory 420, deep processing unit (DPU) 421, AI processor 422, system components and resources 424, an interconnection/bus module 426, one or more temperature sensors 430, a thermal management unit 432, and a thermal power envelope (TPE) component 434. The second SOC 404 may include a 5G modem processor 452, a power management unit 454, an interconnection/bus module 464, a plurality of mmWave transceivers 456, memory 458, and various additional processors 460, such as an applications processor, packet processor, etc.

Each processor 410, 412, 414, 416, 418, 421, 422, 452, 460 may include one or more cores, and each processor/core may perform operations independent of the other processors/cores. For example, the first SOC 402 may include a processor that executes a first type of operating system (e.g., FreeBSD, LINUX, OS X, etc.) and a processor that executes a second type of operating system (e.g., MICROSOFT WINDOWS 10). In addition, any or all of the processors 410, 412, 414, 416, 418, 421, 422, 452, 460 may be included as part of a processor cluster architecture (e.g., a synchronous processor cluster architecture, an asynchronous or heterogeneous processor cluster architecture, etc.).

The first and second SOC 402, 404 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 424 of the first SOC 402 may include power amplifiers, voltage regulators, oscillators, phase-locked loops, peripheral bridges, data controllers, memory controllers, system controllers, Access ports, timers, and other similar components used to support the processors and software clients running on a UE device. The system components and resources 424 may also include circuitry to interface with peripheral devices, such as cameras, electronic displays, wireless communication devices, external memory chips, etc.

The first and second SOC 402, 404 may communicate via interconnection/bus module 450. The various processors 410, 412, 414, 416, 418, may be interconnected to one or more memory elements 420, system components and resources 424 and a thermal management unit 432 via an interconnection/bus module 426. Similarly, the processor 452 may be interconnected to the power management unit 454, the mmWave transceivers 456, memory 458, and various additional processors 460 via the interconnection/bus module 464. The interconnection/bus module 426, 450, 464 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 402, 404 may further include an input/output module (not illustrated) for communicating with resources external to the SOC, such as a clock 406, a voltage regulator 408, screen sensor unit 415 and a wireless transceiver 466 (e.g., cellular wireless transceiver, Bluetooth transceiver, etc.). Resources external to the SOC (e.g., clock 406, voltage regulator 408, screen sensor unit 415, wireless transceiver 466) may be shared by two or more of the internal SOC processors/cores.

In some embodiments, any or all of the processors 410, 412, 414, 416, 418, 421, 422, 452, 460 may implement a CNN-based AI image processing system, a Bilinear-Bicubic image processing pipeline and/or a convolutional neural network super resolution (CNN SR) image processing pipeline. For example, in some embodiments, the GPU 414 and/or DPU 421 may implement a Bilinear-Bicubic pipeline and/or AI processor 422, GPU 414, and/or DSP 410 may implement a CNN SR pipeline.

In some embodiments, any or all of the processors 410, 412, 414, 416, 418, 421, 422, 452, 460 may be configured to work in conjunction with the screen sensor unit 415 to perform a zoom operation on a display of a computing device in accordance with the embodiments. For example, the screen sensor unit 415 may monitor end user's touch gestures to conditionally trigger a layer dynamic seamless zoom and corresponding sequential up-scaling animation frames in continuous varying up-scale step factors (1.0 [symbol] 1.01-1.02 [symbol] 1.03 [symbol] xxxxx [symbol] 1.99, 2.00, 2.01- [symbol] xxxxx [symbol] 3.0). The screen sensor unit 415 may detect a zoom user input on an image layer within the display presented on an electronic display of the computing device, and send the information to the GPU 414 and AI processor 422. The GPU 414 may receive the zoom user input, and use an interpolation scaling technique in a first image processing pipeline to adjust a displayed size of the image layer. In parallel, the AI processor 422 may use a super resolution technique in a second image processing pipeline to adjust the displayed size of the image layer. The AI processor 422, GPU 414 and/or another processor (e.g., applications processor 416) may upscale an output of the interpolation scaling technique on the first image processing pipeline with an output from the super resolution technique on the second image processing pipeline to generate an upscaled frame of the image layer, and cause an electronic display of a computing device to display the upscaled frame of the image layer.

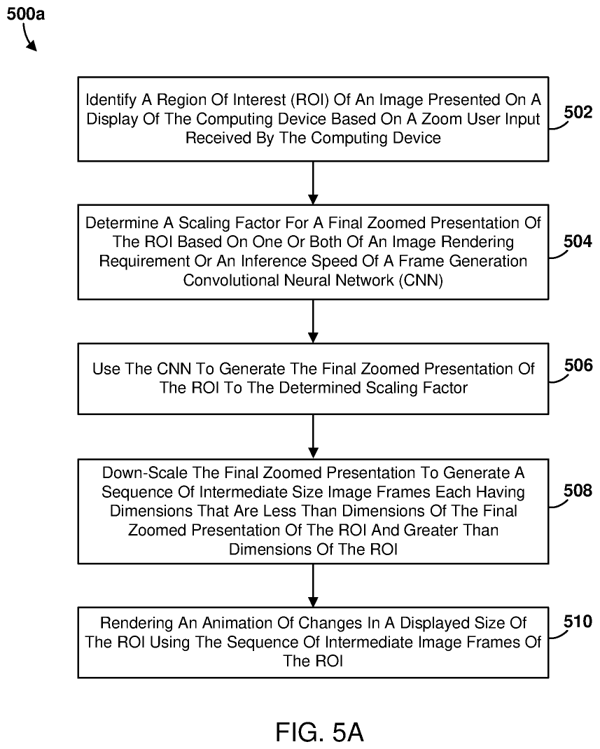

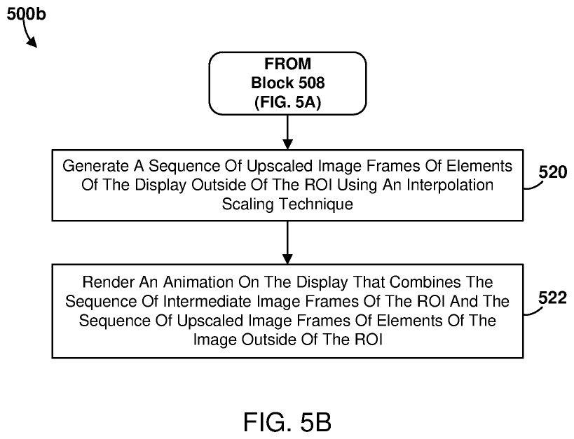

FIG. 5A illustrates a method 500a of performing a zoom operation on a computing device according to various embodiments. With reference to FIGS. 1-5A, means for performing operations of the method 500a may include one or more processors (e.g., processors 410, 412, 414, 416, 418, 421, 422, 452, 460) in a computing device (e.g., 118, 400).

In block 502, the processor may identify an ROI of an image presented on a display of the computing device based on a zoom user input received by the computing device. In some embodiments, the processor may use a regional histogram analysis and/or image segmenting to identify the ROI. In some cases, the processor may identify a particular element (e.g., a face) within an identified ROI, such as using image processing and recognition techniques.

In block 504, the processor may determine a scaling factor for a final zoomed presentation of the ROI based on one or both of an image rendering requirement or an inference speed of a frame generation CNN. In some embodiments, the processor may determine the scaling factor for the final zoomed presentation in response to detecting an initiation of a user zoom input. In some embodiments, the processor may use dimensions of the ROI and dimensions of the display of the computing device in determining the scaling factor for the final zoomed presentation of the ROI. In some embodiments, the processor may use dimensions of an image element within the ROI and dimensions of the display of the computing device in determining the scaling factor for the final zoomed presentation of the ROI. In some embodiments, the image rendering requirement may include a quantity of frames per second (FPS) generated by down-scaling the final zoomed presentation to the generated sequence of intermediate size image frames.

In block 506, the processor may use the CNN to generate the final zoomed presentation of the ROI to the determined scaling factor. In this manner, a final frame of a zoom animation at a predicted or maximum magnification factor or zoom factor may be generated before the image frames of the animation are generated. Thus, instead of incrementally increasing the size of the ROI in each image frame of the animation sequence, the processor may first generate the final image using CNN to render the image in fine detail. While generating this final zoomed presentation of the ROI may take several milliseconds using CNN techniques, this processing may be accomplished within the time between when a user first touches a touch-sensitive display and when the user has moved fingertips apart in a zoom user input to a perceptible degree. In other words, in the time it takes for a user to start moving fingertips apart in a zoom user input, the processor may have generated the final zoomed presentation of the ROI.

In block 508, the processor may down-scale the final zoomed presentation of the ROI to generate a sequence of intermediate size image frames each having dimensions smaller than dimensions of the final zoomed presentation of the ROI and incrementally greater than dimensions of the ROI. In some embodiments, the processor may use a linear scaling technique to perform the down-scaling of the final zoomed presentation to generate the sequence of intermediate size image frames. Given that such down-scaling begins from a high resolution final ROI image generated using CNN processes, each of the down-scaled image frames will exhibit high resolution.

In block 510, the processor may render an animation of changes in a displayed size of the ROI using the sequence of intermediate image frames of the ROI. In particular, the down-scaled image frames may be rendered starting with the smallest image frame with subsequently rendered image frames of increasing size until the final zoomed presentation of the ROI is displayed. In some embodiments, the processor may render the animation of changes in the displayed size of the ROI using the sequence of intermediate image frames in response to the user zoom input. In other words, the processor may match the rate at which increasing (or decreasing) sized image frames are presented on the display to the rate at which the user moves the fingertips apart (to zoom out) or together (to zoom in). Thus, the sequence of intermediate image frames generated in block 508 may be presented on the display in order and at a rate that corresponds (i.e., is responsive to) the user's zoom input.

FIG. 5B illustrates operations 500b that may be performed as part of the method 500a of performing a zoom operation on a computing device according to various embodiments. The operations 500b may be useful when the ROI is present on a display that includes other features and/or a background that is not of interest for zooming. With reference to FIGS. 1-5B, means for performing the operations 500b may include one or more processors (e.g., processors 410, 412, 414, 416, 418, 421, 422, 452, 460) in a computing device (e.g., 118, 400).

Following down-scaling of the final zoomed presentation to generate the sequence of intermediate size image frames each having dimensions smaller than dimensions of the final zoomed presentation of the ROI and greater than dimensions of the ROI in block 508 of the method 500a as described, the processor may generate a sequence of upscaled image frames of elements of the display outside of the ROI using an interpolation (or linear) scaling technique in block 520.

In block 522, the processor may render an animation on the display that combines the sequence of intermediate image frames of the ROI and the sequence of upscaled image frames of elements of the image outside of the ROI.

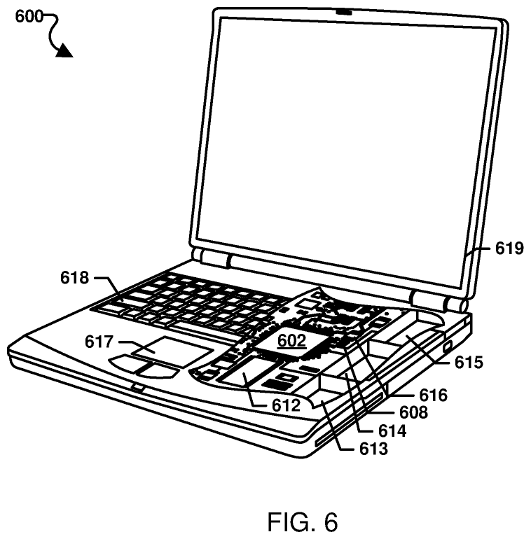

FIG. 6 is a component block diagram of a computing device suitable for use with various embodiments. With reference to FIGS. 1-6, in some embodiments, the computing device may be implemented in the form of a laptop computer 600. In various embodiments, the laptop computer 600 may include a touchpad (or trackpad) touch surface 617 that serves as the computer's pointing device, and thus may receive pinch in, pinch out, drag, scroll, flick gestures, etc. similar to those that may be implemented on computing devices equipped with a touch screen display. The laptop computer 600 may include a processor 602 coupled to volatile memory 612 and a large capacity nonvolatile memory, such as a disk drive 613 of Flash memory. Additionally, the laptop computer 600 may include one or more antenna 608 for sending and receiving electromagnetic radiation that may be connected to a wireless data link and/or cellular telephone transceiver 616 coupled to the processor 602. The laptop computer 600 may also include a transceiver 614 implementing short range wireless communication using a variety of short-range communication protocols, such as any of the Institute of Electrical and Electronics Engineers (IEEE) 802.11 and 802.15 protocols. The laptop computer 600 also may include a compact disc (CD) drive 615 coupled to the processor 602. The laptop computer 600 may include a touchpad 617, a keyboard 618, and a display 619 all coupled to the processor 602. Other configurations of the laptop computer 600 may include a computer mouse or trackball coupled to the processor (e.g., via a Universal Serial Bus (USB) input) as are well known, which may also be used in conjunction with various embodiments.

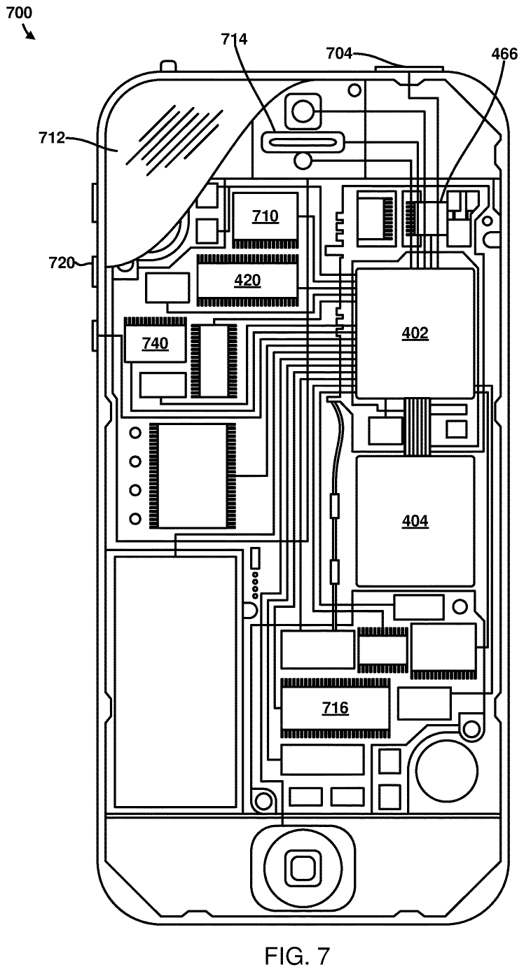

FIG. 7 is a component block diagram of a computing device suitable for use with various embodiments. With reference to FIGS. 1-7, in some embodiments, the computing device may be implemented in the form of a smartphone 700. The smartphone 700 may include a first circuitry 402 coupled to a second circuitry 404. The first and second SoCs 402, 404 may be coupled to internal memory 716, a display 712, and to a speaker 714. The display 712 may include or incorporate a touch sensitive input device configured to receive an input such as pinch in, pinch out, drag, scroll, flick gestures, etc. The first and second circuitries 402, 404 may also be coupled to at least one subscriber identity module (SIM) 740 and/or a SIM interface that may store information supporting a first 5GNR subscription and a second 5GNR subscription, which support service on a 5G non-standalone (NSA) network.

The smartphone 700 may include an antenna 704 for sending and receiving electromagnetic radiation that may be connected to a wireless transceiver 466 coupled to one or more processors in the first and/or second circuitries 402, 404. The smartphone 700 also may include menu selection buttons or rocker switches 720 for receiving user inputs. The smartphone 700 also may include a sound encoding/decoding (CODEC) circuit 710, which digitizes sound received from a microphone into data packets suitable for wireless transmission and decodes received sound data packets to generate analog signals that are provided to the speaker to generate sound. Also, one or more of the processors in the first and second circuitries 402, 404, wireless transceiver 466 and CODEC 710 may include a digital signal processor (DSP) circuit 740.

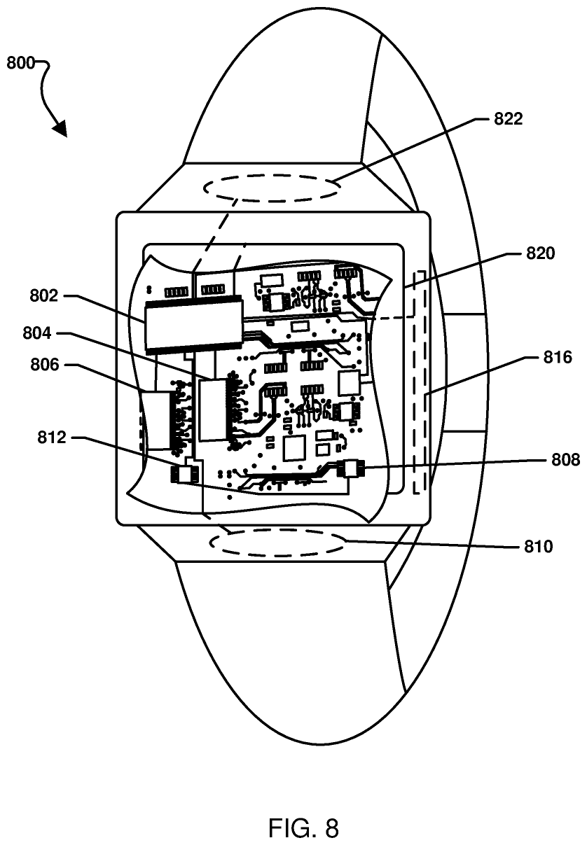

FIG. 8 is a component block diagram of a computing device suitable for use with various embodiments. With reference to FIGS. 1-8, in some embodiments, the computing device may be implemented in the form of a smart watch 800.

The smart watch 800 may include an SoC 802 including two or more processors (e.g., application processor, low power processor) coupled to internal memories 804 and 806. Internal memories 804, 806 may be volatile or non-volatile memories, and may also be secure and/or encrypted memories, or unsecure and/or unencrypted memories, or any combination thereof. The SoC 802 may also be coupled to a touchscreen display 820, such as a resistive-sensing touchscreen, capacitive-sensing touchscreen infrared sensing touchscreen, or the like. Additionally, the smart watch 800 may have one or more antenna 808 for sending and receiving electromagnetic radiation that may be connected to one or more wireless data links 812, such as one or more Bluetooth® transceivers that may be coupled to the SoC 802.

The smart watch 800 may also include physical and/or virtual buttons 822 and 810 for receiving user inputs as well as a slide sensor 816 for receiving user inputs. The touchscreen display 820 may be coupled to a touchscreen interface module that is configured receive signals from the touchscreen display 820 indicative of locations on the screen where a user's fingertip or a stylus is touching the surface and output to the SoC 802 information regarding the coordinates of touch events. The physical and/or virtual buttons 822 and touchscreen display 820 may be configured to receive an input such as pinch in, pinch out, drag, scroll, flick gestures, etc. Further, the SoC 802 may be configured with processor-executable instructions to correlate images presented on the touchscreen display 820 with the location of touch events received from the touchscreen interface module in order to detect when a user has interacted with a graphical interface icon, such as a virtual button.

The SoC 802 may be any programmable microprocessor, microcomputer or multiple processor chip or chips that can be configured by software instructions (applications) to perform a variety of functions, including the functions of various embodiments. In some devices, multiple processors may be provided, such as one processor dedicated to wireless communication functions and one processor dedicated to running other applications. Typically, software applications may be stored in an internal memory before they are accessed and loaded into the SoC 802. The SoC 802 may include internal memory sufficient to store the application software instructions. In many devices the internal memory may be a volatile or nonvolatile memory, such as flash memory, or a mixture of both. For the purposes of this description, a general reference to memory refers to memory accessible by the SoC 802 including internal memory or removable memory plugged into the wearable device and memory within the SoC 802 itself.

The processors of the laptop computer 600, the smart phone 700, and the smart watch 800 may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method of performing a zoom operation on a computing device, including identifying a region of interest (ROI) of an image presented on a display of the computing device based on a zoom user input received by the computing device, determining a scaling factor for a final zoomed presentation of the ROI based on one or both of an image rendering requirement or an inference speed of a frame generation convolutional neural network (CNN), using the CNN to generate the final zoomed presentation of the ROI to the determined scaling factor, down-scaling the final zoomed presentation to generate a sequence of intermediate size image frames each having dimensions smaller than dimensions of the final zoomed presentation of the ROI and greater than dimensions of the ROI, and rendering an animation of changes in a displayed size of the ROI using the sequence of intermediate image frames of the ROI.

Example 2. The method of example 1, in which the image rendering requirement includes a quantity of frames per second (FPS) generated by down-scaling the final zoomed presentation to the generated sequence of intermediate size image frames.

Example 3. The method of either of examples 1 or 2, in which down-scaling the final zoomed presentation to generate a sequence of intermediate size image frames is performed using a linear scaling technique.

Example 4. The method of any of examples 1-3, in which determining the scaling factor for the final zoomed presentation and using the CNN to generate the final zoomed presentation is performed in response to detecting an initiation of the user zoom input, and rendering the animation of changes in the displayed size of the ROI using the sequence of intermediate image frames is performed responsive to the user zoom input.

Example 5. The method of any of examples 1-4, in which determining the scaling factor for the final zoomed presentation of the ROI is further based on dimensions of the ROI and dimensions of the display of the computing device.

Example 6. The method of any of examples 1-5, in which determining the scaling factor for the final zoomed presentation of the ROI is further based on dimensions of an image element within the ROI and dimensions of the display of the computing device.

Example 7. The method of any of examples 1-6, further including generating a sequence of upscaled image frames of elements of the display outside of the ROI using an interpolation scaling technique, in which rendering the animation of changes in the displayed size of the ROI using the sequence of intermediate image frames of the ROI includes rendering an animation on the display that combines the sequence of intermediate image frames of the ROI and the sequence of upscaled image frames of elements of the image outside of the ROI.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method of performing a zoom operation on a computing device, comprising:
identifying a region of interest (ROI) of an image presented on a display of the computing device based on a zoom user input received by the computing device;
determining a scaling factor for a final zoomed presentation of the ROI based on one or both of an image rendering requirement or an inference speed of a frame generation convolutional neural network (CNN);
using the CNN to generate the final zoomed presentation of the ROI to the determined scaling factor;
down-scaling the final zoomed presentation to generate a sequence of intermediate size image frames each having dimensions smaller than dimensions of the final zoomed presentation of the ROI and greater than dimensions of the ROI; and
rendering an animation of changes in a displayed size of the ROI using the sequence of intermediate image frames of the ROI.

2. The method of claim 1, wherein the image rendering requirement comprises a quantity of frames per second (FPS) generated by down-scaling the final zoomed presentation to the generated sequence of intermediate size image frames.

3. The method of claim 1, wherein down-scaling the final zoomed presentation to generate the sequence of intermediate size image frames is performed using a linear scaling technique.

4. The method of claim 1, wherein:
determining the scaling factor for the final zoomed presentation and using the CNN to generate the final zoomed presentation is performed in response to detecting an initiation of the user zoom input; and
rendering the animation of changes in the displayed size of the ROI using the sequence of intermediate image frames is performed responsive to the user zoom input.

5. The method of claim 1, wherein determining the scaling factor for the final zoomed presentation of the ROI is further based on dimensions of the ROI and dimensions of the display of the computing device.

6. The method of claim 1, wherein determining the scaling factor for the final zoomed presentation of the ROI is further based on dimensions of an image element within the ROI and dimensions of the display of the computing device.

7. The method of claim 1, further comprising:
generating a sequence of upscaled image frames of elements of the display outside of the ROI using an interpolation scaling technique,
wherein rendering the animation of changes in the displayed size of the ROI using the sequence of intermediate image frames of the ROI comprises rendering an animation on the display that combines the sequence of intermediate image frames of the ROI and the sequence of upscaled image frames of elements of the image outside of the ROI.

8. A computing device, comprising:
a display; and
a processor coupled to the display and configured with processor-executable instructions to:
identify a region of interest (ROI) of an image presented on the display based on a zoom user input received by the computing device;
determine a scaling factor for a final zoomed presentation of the ROI based on one or both of an image rendering requirement or an inference speed of a frame generation convolutional neural network (CNN);
use the CNN to generate the final zoomed presentation of the ROI to the determined scaling factor;
down-scale the final zoomed presentation to generate a sequence of intermediate size image frames each having dimensions smaller than dimensions of the final zoomed presentation of the ROI and greater than dimensions of the ROI; and
render on the display an animation of changes in a displayed size of the ROI using the sequence of intermediate image frames of the ROI.

9. The computing device of claim 8, wherein the processor is further configured with processor-executable instructions such that the image rendering requirement comprises a quantity of frames per second (FPS) generated by down-scaling the final zoomed presentation to the generated sequence of intermediate size image frames.

10. The computing device of claim 8, wherein the processor is further configured with processor-executable instructions to down-scale the final zoomed presentation to generate the sequence of intermediate size image frames using a linear scaling technique.

11. The computing device of claim 8, wherein the processor is further configured with processor-executable instructions to:
determine the scaling factor for the final zoomed presentation and using the CNN to generate the final zoomed presentation in response to detecting an initiation of the user zoom input; and
render on the display the animation of changes in the displayed size of the ROI using the sequence of intermediate image frames responsive to the user zoom input.

12. The computing device of claim 8, wherein the processor is further configured with processor-executable instructions to determine the scaling factor for the final zoomed presentation of the ROI based on dimensions of the ROI and dimensions of the display of the computing device.

13. The computing device of claim 8, wherein the processor is further configured with processor-executable instructions to determine the scaling factor for the final zoomed presentation of the ROI based on dimensions of an image element within the ROI and dimensions of the display of the computing device.

14. The computing device of claim 8, wherein the processor is further configured with processor-executable instructions to:
generate a sequence of upscaled image frames of elements of the display outside of the ROI using an interpolation scaling technique; and
render an animation on the display that combines the sequence of intermediate image frames of the ROI and the sequence of upscaled image frames of elements of the image outside of the ROI.

15. A computing device, comprising:
means for identifying a region of interest (ROI) of an image presented on a display of the computing device based on a zoom user input received by the computing device;
means for determining a scaling factor for a final zoomed presentation of the ROI based on one or both of an image rendering requirement or an inference speed of a frame generation convolutional neural network (CNN);
means for using the CNN to generate the final zoomed presentation of the ROI to the determined scaling factor;
means for down-scaling the final zoomed presentation to generate a sequence of intermediate size image frames each having dimensions smaller than dimensions of the final zoomed presentation of the ROI and greater than dimensions of the ROI; and
means for rendering an animation of changes in a displayed size of the ROI using the sequence of intermediate image frames of the ROI.

16. The computing device of claim 15, wherein the image rendering requirement comprises a quantity of frames per second (FPS) generated by down-scaling the final zoomed presentation to the generated sequence of intermediate size image frames.

17. The computing device of claim 15, wherein means for down-scaling the final zoomed presentation to generate the sequence of intermediate size image frames uses a linear scaling technique.

18. The computing device of claim 15, wherein:
means for determining the scaling factor for the final zoomed presentation and using the CNN to generate the final zoomed presentation comprises means for determining the scaling factor for the final zoomed presentation and using the CNN to generate the final zoomed presentation in response to detecting an initiation of the user zoom input; and
means for rendering the animation of changes in the displayed size of the ROI using the sequence of intermediate image frames comprises means for rendering the animation of changes in the displayed size of the ROI using the sequence of intermediate image frames responsive to the user zoom input.

19. The computing device of claim 15, wherein means for determining the scaling factor for the final zoomed presentation of the ROI comprises means for determining the scaling factor for the final zoomed presentation of the ROI based on dimensions of the ROI and dimensions of the display of the computing device.

20. The computing device of claim 15, wherein means for determining the scaling factor for the final zoomed presentation of the ROI comprises means for determining the scaling factor for the final zoomed presentation of the ROI based on dimensions of an image element within the ROI and dimensions of the display of the computing device.

21-28. (canceled)
